(19) United States
(12) Patent Application Publication
(10) Pub. No.: US 2008/0085406 A1
(43) Pub. Date: Apr. 10, 2008

(54) Light Diffusing Optical Member

(75) Inventors: Tatsuo Kusayanagi, Kanagawa (JP); Akihiko Takeda, Kanagawa (JP); Akira Ichiki, Kanagawa (JP)

Correspondence Address: SUGHRUE-265550, 2100 PENNSYLVANIA AVE. NW, WASHINGTON, DC, 20037-3213, US

(73) Assignee: Fujifilm Corporation, Tokyo (JP)

(21) Appl. No.: 11/884,662

(22) PCT Filed: Feb. 17, 2006
(86) PCT No.: PCT/JP06/02866

§ 371 Date: Sep. 12, 2007

(30) Foreign Application Priority Data
Feb. 18, 2005 (JP) 2005-042355

(51) Int. Cl. B32B 5/02; B05D 5/06

(52) U.S. Cl. 428/221; 427/162

(57) ABSTRACT

An optical member having a light diffusing layer which hardly causes a whitening phenomenon by an organic solvent is provided. An optical member including a transparent support made from a translucent resin having thereon at least one light diffusing layer containing an organic polymer fine particle, wherein the light diffusing layer is formed by coating a hydrophilic binder.

### TECHNICAL FIELD

The present invention relates to a light diffusing optical member which is used for a liquid crystal display device used for image displaying in computers, word processors, television sets and the like and which is intended to enhance the display quality and in particular to improve a viewing angle characteristic and to a method for producing the same.

### BACKGROUND ART

In general, a liquid crystal display is configured of a polarizing plate and a liquid crystal cell. In a TN mode TFT liquid crystal display which is the mainstream at present, an optically compensatory film is inserted between a polarizing plate and a liquid crystal cell, whereby a liquid crystal display with high display quality is realized.

However, in the foregoing liquid crystal display, there remained a problem that gradation inversion in a lower direction of a panel is caused. With respect to this problem, by providing light diffusion means, for example, a light diffusing sheet on a surface on a viewing side, the display quality is remarkably improved. Such a light diffusing sheet is required to have properties such that it is good in light diffusibility, free from coloration and excellent in light transmission properties.

The foregoing light diffusing sheet is demanded to have high light transmission properties in addition to the light diffusibility, and various proposals have been made. For example, Patent Document 1 (Japanese Patent No. 3413273) proposes a light diffusing sheet comprising a transparent support sheet having thereon a light diffusing layer, wherein a polymer layer composed of a crosslinked material of an ion conductive resin having a cationic quaternary ammonium base in a side chain thereof is provided between the support sheet and the light diffusing layer, as a light diffusing sheet which is remarkably enhanced in light transmission properties although it is equal to conventional light-diffusing sheets with respect to materials, thickness and the like of the transparent support and diffusing layer. Also, Patent Document 2 (JP-A-6-59107) proposes a light diffusing sheet capable of extremely increasing outputted light to a front direction and being enhanced in transmittance and the like by including a transparent resin, a synthetic resin particle and a particle having a refractive index higher than a refractive index of the transparent resin in a light diffusing layer. However, further enhancement of the light transmission properties of the light diffusing sheet is demanded.

Also, in major cases, for the purpose of light diffusion, a fine particle is blended in the light diffusing layer of the light diffusing sheet, but there was a problem of coloration caused due to this. On the other hand, Patent Document 3 (JP-A-11-142618) proposes a light diffusing sheet which is a light diffusing sheet of a particle dispersion type in which a particle is dispersed in a light diffusing layer and which uses a combination of two or more kinds of particles having a different average particle size from each other within the range of not more than 50% in the particle size distribution for reducing the coloration of transmitted light.

However, during handling works of a member having a light diffusing layer or a surface luminant device provided with a member of a light diffusing layer, in order to remove stains such as dusts of the light diffusing layer of the member having an exposed light diffusing layer, it is frequently carried out to rinse a surface of the light diffusing layer with an appropriate organic solvent such as alcohols, for example, ethanol and isopropanol, and the conventional light diffusing layer is liable to cause whitening due to rinsing with an alcohol. When the light diffusing sheet causes a whitening phenomenon, there are possibilities that the quantity of transmitted light is decreased and that uniformity of the light becomes worse, whereby it is no longer useful as a surface luminant device. By using, as a polymer binder of the light diffusing layer, a hydrophilic binder but not an organic solvent-soluble binder, a whitening phenomenon is not substantially caused due to rinsing with an alcohol. Also, in a conventional manufacturing method of a light diffusing sheet, there is a possibility that the organic solvent is discharged into the atmosphere, and adverse affects against the environment are apprehensive.

Patent Document 1: Japanese Patent No. 3413273

Patent Document 2: JP-A-6-59107

Patent Document 3: JP-A-11-142618

### DISCLOSURE OF THE INVENTION

### Problems that the Invention is to Solve

An object of the invention is to provide an optical member having a light diffusing layer, which is characterized in that by using a hydrophilic binder, a whitening phenomenon due to an organic solvent is hardly caused. Simultaneously, since it becomes possible to achieve a coating system not using an organic solvent, adverse affects against the environment are largely improved.

### Means for Solving the Problems

According to the invention, an optical member having a light diffusing layer of the following configuration is provided, whereby the foregoing object of the invention is achieved.

1. An optical member comprising a transparent support made from a translucent resin having thereon at least one light diffusing layer containing an organic polymer fine particle, wherein at least one of layers constituting the optical member contains a hydrophilic binder.

2. The optical member as set forth above in 1, which is characterized in that the light diffusing layer contains a hydrophilic binder.

3. The optical member as set forth above in 1 or 2, which is characterized in that the hydrophilic binder is gelatin.

4. The optical member as set forth above in 1 or 2, which is characterized in that the hydrophilic binder is chitosan.

5. The optical member as set forth above in 1 or 2, which is characterized in that the hydrophilic binder is polyvinyl alcohol.

6. The optical member as set forth above in 1 or 2, which is characterized in that the hydrophilic binder is a mixture of at least two members selected from the binders as set forth above in 3 thru 5.

7. The optical member as set forth above in any one of 1 thru 6, which is characterized in that the light diffusing layer contains an organic polymer fine particle or an inorganic particle or a mixed composition thereof.

8. The optical member as set forth above in any one of 1 thru 7, which is characterized in that the hydrophilic binder-containing layer contains a hardening agent.

9. The optical member as set forth above in any one of 1 thru 8, which is characterized in that a layer containing a fine particle is provided on both surfaces of the support.

10. The optical member as set forth above in 1, which is characterized in that the hydrophilic binder-containing layer contains a fluorine-containing surfactant.

11. A method for producing an optical member comprising a transparent support made from a translucent resin having thereon at least one light diffusing layer containing an organic polymer fine particle, which is characterized by forming at least one of layers constituting the optical member by a coating liquid containing a hydrophilic binder.

### ADVANTAGES OF THE INVENTION

Hitherto, during handling works of a member having a light diffusing layer or a surface luminant device provided with a member of a light diffusing layer, in order to remove stains such as dusts of the light diffusing layer of the member having an exposed light diffusing layer, it is frequently carried out to rinse the light diffusing layer with an appropriate organic solvent such as alcohols, for example, ethanol and isopropanol, and since the conventional light diffusing layer uses an organic solvent, it is liable to cause whitening due to rinsing with an alcohol. When the light diffusing sheet causes a whitening phenomenon, there are possibilities that the quantity of transmitted light is decreased and that uniformity of the light becomes worse, whereby it is no longer useful as a surface luminant device. By using, as a polymer binder of the light diffusing layer, a hydrophilic binder but not an organic solvent-soluble binder, a whitening phenomenon is not substantially caused due to rinsing with an alcohol.

### BRIEF DESCRIPTION OF THE DRAWING

FIG. 1 is a schematic cross-sectional view to show an embodiment of an optical member having a light diffusing layer obtained by a manufacturing method of the invention.

### DESCRIPTION OF REFERENCE NUMERALS AND SIGNS

11: Optical member having a light diffusing layer
12: Transparent support
13: Undercoat layer
14: Backcoat layer
15: Light diffusing layer

### BEST MODES FOR CARRYING OUT THE INVENTION

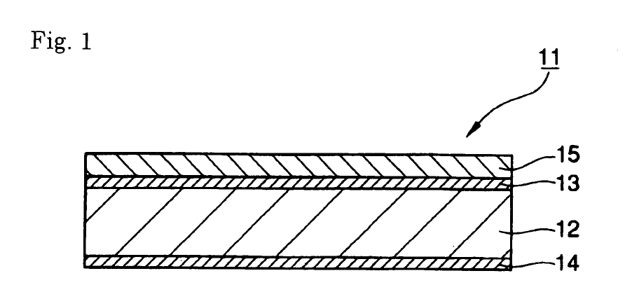

First of all, an outline of the optical member having a light diffusing layer of the invention is described with reference to FIG. 1.

FIG. 1 is a schematic cross-sectional view to show an embodiment of the optical member having a light diffusing layer of the invention. In FIG. 1, an optical member 11 having a light diffusing layer is configured to include a light diffusing layer 14 on one surface of a support 12. In order to enhance adhesiveness between the support 12 and the light diffusing layer 14, an undercoat layer 13 may be formed. A back layer may also be provided on the other one surface of the support 12.

<Support>

The support may be any usually known sheet having good transparency and sufficient mechanical strengths. As a material of the transparent support, plastics are in general used, and it may be glass as the case may be. Examples of the plastic (translucent resin) which is preferably used as a material of the transparent support include polyesters (for example, polyethylene terephthalate and polyethylene naphthalate), polyolefins (for example, polyethylene and polypropylene), polyamides, polyethers, polystyrenes, polyester amides, polycarbonates, polyphenylene sulfide, polyether esters, polyvinyl chloride, and polyacrylic esters or polymethacrylic esters (preferably, methacrylic resins (PMMA)). In general, a thickness of the transparent support is preferably from 0.02 mm to 4.0 mm. For the purpose of enhancing adhesiveness to the light diffusing layer, the surface of the transparent support may be subjected to surface treatment such as discharge treatment or may be provided with an adhesive layer, an undercoat layer, or the like.

<Undercoat Layer and Backcoat Layer>

In order to enhance the adhesiveness between the support and the light diffusing layer, an undercoat layer may also be provided. For example, when the light diffusing layer sheet is wound up in a roll shape, in order to prevent the adhesion between an upper side and a lower side of the sheet, a backcoat layer may be provided, too.

FIG. 1 is a schematic cross-sectional view to show an embodiment of the optical member having a light diffusing layer of the invention. In FIG. 1, an optical member 11 having a light diffusing layer is configured such that an adhesive layer 13 and a backcoat layer (BC layer) 14 are formed on both surfaces of a transparent support 12, respectively and that a light diffusing layer 15 is provided on the adhesive layer 13.

With respect to the backcoat layer as referred to in the invention, a layer which is provided on an opposite side to a side of at least one diffusing layer on an undercoat layer applied on one surface of a support while sandwiching the support is named generically as a backcoat layer. This backcoat layer may be a layer provided by coating on an undercoat layer similar to the diffusing layer or may be provided by coating directly on the surface-treated support without providing an undercoat layer. For the purpose of improving the adhesion between the support and the backcoat layer, the undercoat layer may include two or more layers. Even when an undercoat layer is provided, a layer exclusive of this undercoat layer is named generically as the backcoat layer to which the invention refers. The backcoat layer is provided as a principal object for imparting various functions. Examples of various functions as referred to herein include prevention of adhesion in handling, impartation of slipperiness and prevention of curl; in order to impart these functions, an antistatic agent, a fine particle, a slipping agent, an anti-curl agent, and the like are used; and a binder for supporting such a compound or the like, a hardening agent, a plasticizer, a surfactant, a coating aid, and the like are used jointly. In the invention, the backcoat layer which is provided for the purpose of imparting the foregoing various functions contains the foregoing several compounds depending upon the functions. These compounds may be included in a single layer or may be included in two or more layers depending upon the functions to be imparted. Accordingly, the backcoat layer is configured of at least one layer.

In the invention, a coating liquid composition of an outermost layer of the backcoat layer is a composition containing at least one kind of each of a slipping agent and a cationic surfactant or an anionic surfactant.

A thickness of each of the adhesive layer 13 and the BC layer 14 is preferably from 0.05 to 5 μm, and more preferably from 0.5 to 4.5 μm. What the thickness of each of the adhesive layer 13 and the BC layer 14 falls within the foregoing range is preferable from the standpoints of light transmission properties and prevention of blocking fault.

More preferably, by adding an organic polymer fine particle to be used in a BC layer as described below, not only the light transmission properties are remarkably enhanced, but an improvement in the viewing angle can be achieved. The amount of addition of the organic polymer fine particle is preferably not more than 250% by mass, and more preferably from 0.01% by mass to 200% by mass relative to the resin.

An antistatic layer made from an inorganic conductive material is very useful; and above all, preferred examples of the antistatic agent include fine particles of at least one metal oxide selected among ZnO, TiO₂, SnO₂, Al₂O₃, In₂O₃, SiO₂, MgO, BaO, MoO₃, and V₂O₅ and composite oxides thereof (for example, Sb, P, B, In, S, Si and C); and these may be crystalline or in a sol shape. The antistatic agent may also be a conductive carbon particle. The fine particles of a conductive crystalline or sol-shaped metal oxide or its composite oxide which is used in the invention preferably has a volume resistivity of not more than 10⁷ Ω·cm, and more preferably not more than 10⁵ Ω·cm. A shape of the fine particle is not particularly limited, and examples thereof include various shapes such as a spherical shape, a rod shape, an acicular shape, a flaky shape, and a plate shape. The fine particle may be in a hollow shape, and a raw material called as a carbon nanotube can also be used. A primary particle size of the fine particle is desirably from 0.00001 to 2 μm, and especially desirably from 0.0001 to 1 μm. In order to impart conductivity more efficiently, it is preferred to use a fine particle of a conductive crystalline or sol-shaped oxide or its composite oxide obtained by aggregating a part of primary fine particles (for example, an aggregate of from 2 to 10,000 particles) to regulate the size at from 0.01 to 0.5 μm or an aggregate of fillers. Such a conductive particle is not particularly limited with respect to the relationship between the crystallite size and the particle size; and when the particle has high crystallinity, a ratio of the crystallite size and the particle size is 1/1, whereas when the particle has low crystallinity and is amorphous, the subject ratio is possibly 1/2000.

In particular, in the conductive material which is used in the invention, a conductive antimony-containing or adherent tin oxide fine powder is useful, and such is easily available as a commercial product and includes spherical and acicular raw materials. An acicular conductive antimony-containing tin oxide powder which is especially useful among them is described in detail. This is characterized by having an acicular conductive antimony-containing tin oxide powder having a minor axis average particle size of from 0.005 to 1 μm, a major axis average particle size of from 0.05 to 10 μm, an aspect ratio of 3 or more and a specific resistance of not more than 1 kΩ·cm on at least one side thereof and is described below in detail. The term “acicular” as referred to herein includes, in addition to the acicular shape, a fibrous shape, a columnar shape, a rod shape, a flaky shape, and other analogous shapes within the range of physical properties thereof. The acicular conductive antimony-containing tin oxide fine power can be obtained by baking after deposition of hydrated antimony on a surface of acicular tin oxide as a basic particle. It can also be prepared by including antimony oxide in advance at a stage of preparing tin oxide. The acicular conductive antimony-containing tin oxide fine powder which is used in the invention is not particularly limited with respect to a preparation method thereof, and the preparation method is described in, for example, JP-A-9-12314, JP-A-8-231222, JP-A-8-217445, JP-A-8-217444, U.S. Pat. No. 5,575,957, EP-719730, JP-A-56-120519, and JP-A-62-158199 in detail.

The acicular conductive antimony-containing or adherent tin oxide fine powder which is preferably used in the invention has a minor axis average particle size of from 0.005 to 1 μm, a major axis average particle size of from 0.05 to 10 μm, an aspect ratio of 3 or more and a specific resistance of not more than 1 kΩ·cm on at least one side thereof. The minor axis average particle size is preferably from 0.005 to 0.5 μm, and more preferably from 0.005 to 0.2 μm; and the major axis average particle size is from 0.05 to 10 μm, more preferably from 0.1 to 5 μm, and especially preferably from 0.1 to 3. The aspect ratio of the minor axis average particle size and the major axis average particle size is 3 or more, preferably 5 or more, and especially preferably 7 or more. The specific resistance of the acicular conductive antimony-containing tin oxide fine powder is not more than 1 kΩ·cm, preferably not more than 500 Ω·cm, and especially preferably 100 Ω·cm. In order to impart conductivity more efficiently, it is preferred to use an aggregate of an acicular conductive antimony-containing or adherent tin oxide fine powder obtained by aggregating a part of primary fine particles to regulate the size at from 0.05 to 1.0 μm. The conductivity as achieved when the antistatic layer is prepared by using such a fine powder is preferably not more than 10¹² Ω·cm, more preferably not more than 10¹⁰ Ω·cm, and especially preferably 10^{9.5} Ω·cm in terms of electrical resistance. In that case, in general, the content in the antistatic layer is preferably from 5 to 1,000 mg/m², and especially preferably from 10 to 500 mg/m². The amount of the binder is preferably from 5 to 1,000 mg/m², and especially preferably from 5 to 500 mg/m². A ratio of the amount of the acicular conductive antimony-containing or adherent tin oxide fine powder and the amount of the binder is preferably from 1/300 to 100/1, and more preferably from 1/100 to 100/5.

<Light Diffusing Layer>

In the invention, the light diffusing layer is one formed by dispersing and fixing a number of organic polymer fine particles by a binder.

As the organic polymer fine particle, particles formed of an organic polymer such as crosslinking type acrylic resins and methacrylic resins, polyethylene, polypropylene, polystyrene, silicone resins, and melamine resins are preferable; and crosslinking type acrylic resins or methacrylic resins (for example, PMMA resins) are especially preferable. A mass average particle size of the organic polymer fine particle is preferably from 1 to 100 μm, and especially preferably from 1 to 25 μm.

Examples of a hydrophilic binder which is used in the invention include those described in Research Disclosure and JP-A-64-13546, pages 71 to 75. Concretely, transparent or semi-transparent hydrophilic binders are preferable, and examples thereof include natural compounds, for example, proteins or cellulose derivatives such as gelatin and gelatin derivatives and polysaccharides such as starch, gum arabic, dextran, and pullulan and synthetic high molecular compounds, for example, polyvinyl alcohol, polyvinylpyrrolidone, and acrylamide polymers. Also, highly water-absorbing polymers described in U.S. Pat. No. 4,960,681, JP-A-62-245260, etc., namely homopolymers of a vinyl monomer having —COOM or —SO₃M (wherein M represents a hydrogen atom or an alkali metal) or copolymers among these vinyl monomers or copolymers of such a vinyl monomer with other vinyl monomer (for example, sodium methacrylate, ammonium methacrylate, and SUMIKAGEL L-5H, manufactured by Sumitomo Chemical Co., Ltd.) are useful. A combination of two or more kinds of these binders is also useful, too. In particular, a combination of gelatin with the foregoing binder is preferable.

Gelatin is especially preferable as the binder and may be chosen among lime-processed gelatin, acid-processed gelatin and so-called deashed gelatin in which the content of calcium, etc. is reduced, and a combination of these gelatins is also preferable for use.

In the invention, a coating liquid for the layer containing a hydrophilic binder is preferably a hydrophilic coating liquid. The hydrophilic coating liquid as referred to herein is water or a mixture of water and not more than 70% by mass of a water-miscible organic solvent. Examples of the water-miscible organic solvent include alcohol bases such as methyl alcohol, ethyl alcohol, and propyl alcohol; cellosolve bases such as methyl cellosolve, ethyl cellosolve, and butyl cellosolve; and dimethylformamide.

It is preferable that a combination of materials of the hydrophilic binder and the organic polymer fine particle is chosen such that a difference between a refractive index of the hydrophilic binder and a refractive index of the organic polymer fine particle is not more than 0.20. In general, the light diffusing layer containing the hydrophilic binder and the organic polymer fine particle is formed by coating a coating liquid prepared by adding and mixing the both in water on a support sheet and drying it.

The hardening agent may contain an inorganic or organic hardener. For example, chromates (for example, chromium alum and chromium acetate), aldehydes (for example, formaldehyde, glyoxal, and glutaldehyde), active vinyl compounds (for example, 1,3,4-triacryloyl-hexahydro-s-triazine and 1,3-vinylsulfonyl-2-propanol), or active halogen compounds (for example, 2,4-dichloro-6-hydroxy-striazine) can be used singly or in combination.

The surfactant, especially a fluorocarbon based surfactant is known as a coating aid for imparting homogeneity of a coating film or a raw material capable of bearing both functions to impart antistatic properties of a photographic light-sensitive material; and specific examples thereof are disclosed in, for example, JP-A-49-46733, JP-A-51-32322, JP-A-57-64228, JP-A-64-536, JP-A-2-141739, JP-A-3-95550, JP-A-4-248543, JP-A-2003-270754, and JP-A-8-211526.

Examples of the light diffusing layer include a layer in which a fine particle of an inorganic fine particle is dispersed in a hydrophilic polymer binder. Preferred examples of a matting agent include inorganic fine particles having a mass average particle size of from 1 to 5 μm, such as silica, calcium carbonate, and alumina. The matting agent is in general used in an amount ranging from 20 to 60% by mass relative to the binder.

The prepared coating liquid varies with a coating system and is properly chosen depending upon the coating system and the drying condition, and its solids content is preferably from 10 to 40% by mass, and more preferably from 20 to 30% by mass. A viscosity is preferably from 10 to 100 mpa·s, and more preferably from 20 to 50 mpa·s.

The light diffusing layer of the invention can be formed by dissolving or dispersing the foregoing respective components for the light diffusing layer in water or water mixed with an organic solvent to form a coating liquid, followed by coating on the support and drying.

The coating system which is employed in the invention may be any system capable of achieving multi-layer simultaneous coating such as a slide bead coater, a curtain coater, and an extrusion coater. In particular, examples of the coating system which is suited in the invention include a slide bead coater and a curtain coater. In the case where a slide bead coater or a curtain coater is employed, by flowing a liquid which is not hardened by the hardening agent (herein-after referred to as “dummy liquid”) along a coating width regulating plate and carrying out prevention of aggregation in an edge part, the long-period continuous coating aptitude is enhanced. As the dummy liquid, any liquid which is not hardened by the hardening agent may be used, and in order to minimize influences against the mainstream, it is desired to flow a liquid having a lower viscosity than the mainstream preferably at a rate of from 0.5 to 5 cc/min.

Coating of the coating liquid composition for an outermost layer of the backcoat layer of the invention can be achieved by utilizing a known coating system, for example, air doctor, blade, air knife, squeeze, impregnation, reverse roll, transfer roll, gravure, kiss, cast, spray, dip, bar, extrusion and Geeser coating systems. The diffusing layer and the backcoat layer can also be coated simultaneously.

The optical member having a light diffusing layer of the invention can be used in the same manner as in a conventional light diffusing sheet or the like. For example, the optical member having a light diffusing layer of the invention can be provided on an upper surface of a light guide plate of an edge light type surface luminant device which is used as a back light of a liquid crystal display in such a manner that the light diffusing layer is faced upwardly.

### EXAMPLES

Next, the invention is described with reference to the Examples, but it should not be construed that the invention is limited thereto.

### Example 1

A liquid A which is a coating liquid for an undercoat layer was coated on one surface of a polyethylene terephthalate film (support) having a thickness of 100 μm through a Geeser and dried at 40° C. for 3 minutes to obtain an undercoat layer having a thickness of 1.5 μm. Next, a liquid B which is a coating liquid for a backcoat (BC) layer was coated on an opposite side to the side on which the undercoat layer was coated through a Geeser and dried at 40° C. for 3 minutes to form a BC layer having a thickness of 2.0 μm.

Next, a liquid C which is a coating liquid for a light diffusing layer as described below was coated on a side of the undercoat layer of the coated material as prepared above through a Geeser and allowed to stand at 6° C. for 2 minutes. The coating liquid was then set and dried at 40° C. for 2 minutes to obtain a diffusing sheet. The light diffusing layer had a thickness of 2.0 microns.

(Preparation of Support Having an Undercoat Layer)

A first undercoat layer and a second undercoat layer each having a composition as described below, respectively were coated on both surfaces of a biaxially stretched polyethylene terephthalate support (thickness: 100 μm).

<First Undercoat Layer of Support>

| | | |
|---|---|---|
| Styrene-butadiene based copolymer: | 24.7 | g |
| 2,4-Dichloro-6-hydroxy-s-triazine: | 0.32 | g |
| Polyethyl acrylate: | 0.054 | g |
| Polystyrene fine particle (average particle | 0.007 | g |
| size: 2 μm): | | |
| Surfactant: | 0.02 | g |
| Water to make: | 100 | g in total |

This coating liquid was coated on the polyethylene terephthalate support and dried at 185° C. for one minute to form a first undercoat layer having a dry thickness of 0.5 μm.

<Second Undercoat Layer of Support>

| | | |
|---|---|---|
| Gelatin: | 1 | g |
| Crosslinking agent: | 0.02 | g |
| Proxel: | 3.5 × 10⁻³ | g |
| Acetic acid: | 0.2 | g |
| Water to make: | 100 | g in total |

This coating liquid was coated on the first undercoat layer and dried at 170° C. for one minute to form a second undercoat layer having a dry thickness of 0.1 μm.

(Liquid a for Undercoat Layer)

| | | |
|---|---|---|
| Water: | 146 | g |
| Organic polymer fine particle (polymethyl | 0.1 | g |
| methacrylate crosslinking type, mass average | | |
| particle size: 6.2 μm): | | |
| Gelatin: | 17 | g |
| Surfactant (aerosol): | 2 | g |
| Hardening agent (vinyl sulfonic acid): | 7 | g |

(Liquid B: Coating Liquid for Bc Layer)

| | | |
|---|---|---|
| Water: | 146 | g |
| Organic polymer fine particle (polymethyl | 1 | g |
| methacrylate crosslinking type, mass average | | |
| particle size: 6.2 μm): | | |
| Gelatin: | 17 | g |
| Surfactant (aerosol): | 2 | g |
| Hardening agent (vinyl sulfonic acid): | 7 | g |

(Liquid C: Coating Liquid for Light Diffusing Layer)

| | | |
|---|---|---|
| Water: | 203 | g |
| Gelatin: | 3.4 | g |
| Organic polymer fine particle (polymethyl | 3.0 | g |
| methacrylate crosslinking type, mass average | | |
| particle size: 6.2 (μm): | | |
| Surfactant (aerosol): | 0.1 | g |
| Hardening agent (vinyl sulfonic acid): | 0.15 | g |

### Example 2

The same procedures as in Example 1 were followed, except that the formulation of the liquid C was changed as follows.

(Liquid C: Coating Liquid for Light Diffusing Layer)

| | | |
|---|---|---|
| Water: | 146 | g |
| Organic polymer fine particle (spherical fine | 1 | g |
| particle of a polymethyl methacrylate | | |
| crosslinking type and having a mass average | | |
| particle size of 3.0 μm): | | |
| Gelatin: | 17 | g |
| Surfactant (aerosol): | 2 | g |
| Hardening agent (vinyl sulfonic acid): | 7 | g |

### Example 3

The same procedures as in Example 1 were followed, except that the formulations of the liquids A and B were changed as follows.

(Liquid a: Coating Liquid for Undercoat Layer)

| | | |
|---|---|---|
| Methanol: | 4,165 | g |
| JURYMER SP-50T (manufactured by Nihon Junyaku | 1,495 | g |
| Co., Ltd.) (organic polymer binder): | | |
| Cyclohexanone: | 339 | g |
| JURYMER MB-1X (manufactured by Nihon Junyaku | 1.85 | g |
| Co., Ltd.) (organic polymer fine particle; a | | |
| spherical superfine particle of a polymethyl | | |
| methacrylate crosslinking type and having a | | |
| mass average particle size of 6.2 μm): | | |

(Liquid B: Coating Liquid for Bc Layer)

| | | |
|---|---|---|
| Methanol: | 4,171 | g |
| JURYMER SP-65T (manufactured by Nihon Junyaku | 1,487 | g |
| Co., Ltd.) (organic polymer binder): | | |
| Cyclohexanone: | 340 | g |
| JURYMER MB-1X (manufactured by Nihon Junyaku | 2.68 | g |
| Co., Ltd.) (organic polymer fine particle; a | | |
| spherical superfine particle of a polymethyl | | |
| methacrylate crosslinking type and having a | | |
| mass average particle size of 6.2 μm): | | |

(Liquid C: Coating Liquid for Light Diffusing Layer)

| | | |
|---|---|---|
| Water: | 146 | g |
| Organic polymer fine particle (spherical fine | 1 | g |
| particle having a mass average particle size | | |
| of 3.0 μm): | | |
| Gelatin: | 17 | g |
| Surfactant (aerosol): | 2 | g |
| Hardening agent (vinyl sulfonic acid): | 7 | g |

The same procedures as in Example 1 were followed, except that the formulation of the liquid C was changed as follows.

(Liquid C: Coating Liquid for Light Diffusing Layer)

| | | |
|---|---|---|
| Water: | 146 | g |
| Organic polymer fine particle (spherical fine | 1 | g |
| particle of a polymethyl methacrylate | | |
| crosslinking type and having a mass average | | |
| particle size of 3.0 (μm): | | |
| Chitosan: | 17 | g |
| Surfactant (aerosol): | 2 | g |

### Example 5

The same procedures as in Example 1 were followed, except that the formulation of the liquid C was changed as follows.

(Liquid C: Coating Liquid for Light Diffusing Layer)

| | | |
|---|---|---|
| Water: | 146 | g |
| Organic polymer fine particle (spherical fine | 1 | g |
| particle of a polymethyl methacrylate | | |
| crosslinking type and having a mass average | | |
| particle size of 3.0 μm): | | |
| Polyvinyl alcohol: | 17 | g |
| Surfactant (aerosol): | 2 | g |

### Example 6

The same procedures as in Example 1 were followed, except that the formulation of the liquid C was changed as follows.

(Liquid C: Coating Liquid for Light Diffusing Layer)

| | | |
|---|---|---|
| Water: | 146 | g |
| Organic polymer fine particle (spherical fine | 1 | g |
| particle of a polymethyl methacrylate | | |
| crosslinking type and having a mass average | | |
| particle size of 3.0 μm): | | |
| Polyvinyl alcohol: | 7 | g |
| Gelatin: | 10 | g |
| Surfactant (aerosol): | 2 | g |

### Comparative Example 1

A liquid A which is a coating liquid for an undercoat layer as described below was coated on one surface of a polyethylene terephthalate film (support) having a thickness of 100 μm by a wire bar #10 and dried at 120° C. for 2 minutes to obtain an undercoat layer having a thickness of 1.5 μm. Next, a liquid B which is a coating liquid for a backcoat (BC) layer was coated on an opposite side to the side on which the undercoat layer was coated by a wire bar #10 and dried at 120° C. for 2 minutes to form a BC layer having a thickness of 2.0 μm.

(Liquid a: Coating Liquid for Undercoat Layer)

| | | |
|---|---|---|
| Methanol: | 4,165 | g |
| JURYMER SP-65T (manufactured by Nihon Junyaku | 1,495 | g |
| Co., Ltd.) (organic polymer binder): | | |
| Cyclohexanone: | 339 | g |
| JURYMER MB-1X (manufactured by Nihon Junyaku | 1.85 | g |
| Co., Ltd.) (organic polymer fine particle; a | | |
| spherical superfine particle of a polymethyl | | |
| methacrylate crosslinking type and having a | | |
| mass average particle size of 6.2 μm): | | |

(Liquid B: Coating Liquid for Bc Layer)

| | | |
|---|---|---|
| Methanol: | 4,171 | g |
| JURYMER SP-65T (manufactured by Nihon Junyaku | 1,487 | g |
| Co., Ltd.) (organic polymer binder): | | |
| Cyclohexanone: | 340 | g |
| JURYMER MB-1X (manufactured by Nihon Junyaku | 2.68 | g |
| Co., Ltd.) (organic polymer fine particle; a | | |
| spherical superfine particle of a polymethyl | | |
| methacrylate crosslinking type and having a | | |
| mass average particle size of 6.2 μm): | | |

Next, a liquid C which is a coating liquid for a light diffusing layer as described below was coated on a side of the undercoat layer of the coated material as prepared above by a wire bar #22 and dried at 120° C. for 2 minutes to obtain a diffusing sheet. The light diffusing layer had a thickness of 26.5 μm.

(Liquid C: Coating Liquid for Light Diffusing Layer)

| | | |
|---|---|---|
| Toluene: | 26.79 | g |
| 30% MEK solution of DIANAL BR-80 (organic | 11.90 | g |
| polymer binder, manufactured by Mitsubishi | | |
| Rayon Co., Ltd.): | | |
| JURYMER MB-20X (manufactured by Nihon Junyaku | 11.29 | g |
| Co., Ltd.) (organic polymer fine particle; a | | |
| spherical superfine particle of a polymethyl | | |
| methacrylate crosslinking type and having a | | |
| mass average particle size of 18 μm): | | |
| F780F (manufactured by Dainippon Ink and | 0.03 | g |
| Chemicals, Incorporated, a 30% MEK solution | | |
| of fluorocarbon based surfactant): | | |

The diffusing sheets as prepared above were measured for whitening phenomenon, total light transmittance, haze and diffused light transmittance (all of which were measured by using HZ-1 Model, manufactured by Suga Test Instruments Co., Ltd.) and front luminance and half angle upon being installed in a backlight unit. The results were shown in Table 1.

TABLE 1

| | Whitening | | | | | |
|---|---|---|---|---|---|---|
| | phenomenon | Total light | | Diffused light | Front | |
| | by organic | transmittance | Haze | transmittance | luminance | Half angle |
| | solvent | (%) | (%) | (%) | (cd/cm²) | (°) |
| Example 1 | Yes | 85.0 | 87.9 | 75.5 | 10800 | 32.5 |
| Example 2 | Yes | 84.5 | 88.0 | 75.0 | 10700 | 31.0 |
| Example 2 | Yes | 84.5 | 88.0 | 75.0 | 10700 | 33.0 |
| Example 3 | Yes | 83.5 | 86.0 | 74.0 | 10600 | 31.5 |
| Example 4 | Yes | 85.0 | 87.8 | 75.3 | 10810 | 32.4 |
| Example 5 | Yes | 82.5 | 85.0 | 73.0 | 10500 | 31.0 |
| Example 6 | Yes | 83.0 | 85.5 | 73.5 | 10550 | 31.2 |
| Comparative | No | 84.5 | 87.7 | 74.5 | 10600 | 32.5 |
| Example 1 | | | | | | |

From the foregoing results, it was demonstrated that when the optical member having a diffusing layer according to the Examples is used, it hardly causes a whitening phenomenon by an organic solvent and is able to be sufficiently put into practical use for color liquid crystal displays.

1. An optical member comprising a transparent support made from a translucent resin having thereon at least one light diffusing layer comprising an organic polymer fine particle, wherein at least one of layers constituting the optical member comprises a hydrophilic binder.

2. The optical member according to in claim 1, wherein the light diffusing layer comprises a hydrophilic binder.

3. The optical member according to in claim 1 or 2, wherein the hydrophilic binder is gelatin.

4. The optical member according to in claim 1 or 2, wherein the hydrophilic binder is chitosan.

5. The optical member according to in claim 1 or 2, wherein the hydrophilic binder is polyvinyl alcohol.

6. The optical member according to in claim 1 or 2, wherein the hydrophilic binder is a mixture of at least two members selected from the binders as claimed in claims 3 to 5.

7. The optical member according to any one of claims 1 to 6, wherein the light diffusing layer comprises an organic polymer fine particle or an inorganic particle or a mixed composition thereof.

8. The optical member according to any one of claims 1 to 7, wherein the hydrophilic binder-containing layer comprises a hardening agent.

9. The optical member according to any one of claims 1 to 8, wherein a layer comprising a fine particle is provided on both surfaces of the support.

10. The optical member according to in claim 1, wherein the hydrophilic binder-containing layer comprises a fluorine-containing surfactant.

11. A method for producing an optical member comprising a transparent support made from a translucent resin having thereon at least one light diffusing layer containing an organic polymer fine particle, wherein at least one of layers constituting the optical member is formed by a coating liquid comprising a hydrophilic binder.
